(19) United States
(12) Patent Application Publication
(10) Pub. No.: US 2020/0079080 A1
(43) Pub. Date: Mar. 12, 2020

(54) METHOD AND DEVICE FOR IMPROVING THE DROPLET POSITIONING IN AN INKJET

(71) Applicant: Océ Holding B.V., Venlo (NL)

(72) Inventors: Ulrich Stoeckle, Muenchen (DE); Florian Hitzlsperger, Muenchen (DE)

(73) Assignee: Océ Holding B.V., Venlo (NL)

(21) Appl. No.: 16/563,067

(22) Filed: Sep. 6, 2019

(30) Foreign Application Priority Data
Sep. 6, 2018 (DE) 10 2018 121 731.5

(51) Int. Cl. B41J 2/045; B41J 2/135

(52) U.S. Cl. CPC B41J 2/04596; B41J 2/135; B41J 2/04581

(57) ABSTRACT

In preparation for an ejection pulse for printing a dot in a subsequent line, the actuator of a nozzle of an inkjet printer is activated in a current line with an excitation pulse via which no ink ejection is produced although an oscillation of ink in the nozzle is produced. The oscillation that is produced by the excitation pulse is thereby matched to the ejection pulse such that the ink droplets that are ejected by the ejection pulse in the subsequent line at least approximately has a defined target droplet velocity. The droplet velocity of the ejected ink droplets, and thus the droplet positioning, may thus be made uniform via the use of excitation pulses.

### CROSS REFERENCE TO RELATED APPLICATIONS

This patent application claims priority to German Patent Application No. 102018121731.5, filed Sep. 6, 2018, which is incorporated herein by reference in its entirety.

### BACKGROUND

### Field

The disclosure relates to an inkjet printer. In particular, the disclosure relates to a method and a device with which the accuracy of the positioning of ink droplets may be advantageously increased.

### Related Art

Inkjet printers may be used for printing to recording media (such as paper, for example). For this purpose, most often a plurality of nozzles are used in order to fire ink droplets onto the recording medium, and thus to generate a desired print image on the recording medium.

A nozzle of an inkjet printer may exhibit differences, from line to line, in the positioning of ink droplets on a recording medium. Such fluctuations of the droplet positioning may lead to a negative effect on the print quality. In particular, line blurriness and/or inhomogeneities in print images may be caused by fluctuations of the droplet positioning.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1a is a block diagram of an example of an inkjet printer.

FIG. 1b illustrates a route of an ink droplet between nozzle and recording medium according to an exemplary embodiment of the present disclosure.

FIG. 2a is a schematic illustration of a nozzle according to an exemplary embodiment of the present disclosure.

FIG. 2b illustrates example measurands at a nozzle according to an exemplary embodiment of the present disclosure.

FIG. 2c illustrates print data for activation of the nozzles of a printer according to an exemplary embodiment of the present disclosure.

FIG. 2d illustrates pulses to activate the nozzles of a printer according to an exemplary embodiment of the present disclosure.

FIG. 2e illustrates a correlation between the activation frequency of a nozzle and the droplet velocity according to an exemplary embodiment of the present disclosure.

FIG. 3a illustrates print data for activation of the nozzles of a printer, using an excitation pulse, according to an exemplary embodiment of the present disclosure.

FIG. 3b illustrates an excitation pulse according to an exemplary embodiment of the present disclosure.

FIG. 4 illustrates a flowchart of a method for improving the droplet positioning of nozzles of an inkjet printer according to an exemplary embodiment of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure includes reducing fluctuations of the droplet positioning of a nozzle of an inkjet printer in order to increase the print quality of the inkjet printer.

According to an aspect of the disclosure, a method is described for improving the positioning of ink droplets of an inkjet printer. The printer includes at least one nozzle, where the actuator of the nozzle may be activated according to a line clock cycle in order to print dots in different lines on a recording medium.

In an exemplary embodiment, the method includes the determination that no ink ejection should be produced from the nozzle in a first line, and that an ink ejection should be produced in a subsequent second line. Moreover, the method includes the activation of the actuator of the nozzle for the first line with an excitation pulse that is configured to produce and/or maintain an oscillation of ink in an ink chamber of the nozzle without an ink droplet being ejected from said nozzle. Furthermore, the method includes the activation of the actuator of the nozzle for the second line with an ejection pulse in order to eject an ink droplet from the nozzle.

In an exemplary embodiment, the ejection pulse is configured such that an ink droplet with a target droplet velocity would be produced by the ejection pulse if the actuator of the nozzle were to have also been activated with an ejection pulse for the preceding first line. In an exemplary embodiment, the ejection pulse is configured such that an ink droplet with a deviating droplet velocity would be produced by the ejection pulse if no excitation of the actuator of the nozzle were to take place in the first line. The excitation pulse may be matched to the ejection pulse such that an ink droplet with a compensated droplet velocity is produced by the ejection pulse since an excitation of the actuator of the nozzle with the excitation pulse has taken place in the first line, wherein the compensated droplet velocity is closer to the target droplet velocity than the deviating droplet velocity.

According to a further aspect of the disclosure, an inkjet printer is described for printing to a recording medium. In an exemplary embodiment, the inkjet printer includes at least one nozzle having an actuator that may be activated according to a line clock cycle in order to print dots in different lines onto a recording medium. In an exemplary embodiment, the printer includes a controller that is configured to determine, based on print data with regard to a print image to be printed, that no ejection should be produced by the nozzle in a first line, and an ink ejection should be produced in a subsequent second line. In an exemplary embodiment, the controller is configured to activate the actuator of the nozzle for the first line with an excitation pulse that is configured to produce and/or maintain an oscillation of ink in an ink chamber of the nozzle without an ink droplet being ejected from said nozzle. In an exemplary embodiment, the controller is configured to activate the actuator of the nozzle for the second line with an ejection pulse in order to eject an ink droplet from said nozzle. The excitation pulse and the ejection pulse may be designed as presented above.

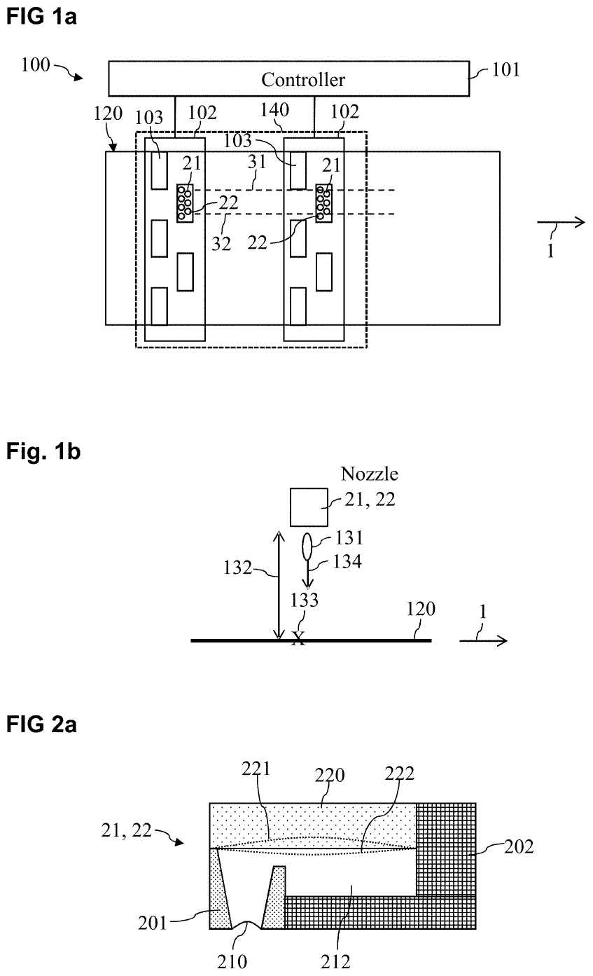

The printer 100 that is depicted in FIG. 1a is configured to print to a recording medium 120 in the form of a sheet or page or plate or band. The recording medium 120 may have been produced from paper, paperboard, cardboard, metal, plastic, textiles, a combination thereof, and/or other materials that are suitable and can be printed to. The recording medium 120 is directed along the transport direction 1 (represented by an arrow) through the print group 140 of the printer 100.

In the depicted example, the print group 140 of the printer 100 includes two print bars 102, where each print bar 102 may be used for printing with ink of a defined color (for example black, cyan, magenta, and/or yellow, and Magnetic Ink Character Recognition (MICR) ink if applicable). In an exemplary embodiment, the printer 100 includes at least one fixer or dryer that is configured to fix a print image printed onto the recording medium 120.

A print bar 102 may include one or more print heads 103 that are, if applicable, arranged side by side in multiple rows in order to print the dots of different columns 31, 32 of a print image onto the recording medium 120. In the example depicted in FIG. 1a, a print bar 102 includes five print heads 103, wherein each print head 103 prints the dots of a group of columns 31, 32 of a print image onto the recording medium 120.

In the embodiment depicted in FIG. 1a, each print head 103 of the print group 140 includes a plurality of nozzles 21, 22, wherein each nozzle 21, 22 is configured to fire or eject ink droplets onto the recording medium 120. A print head 103 of the print group 140 may, for example, include multiple thousands of effectively utilized nozzles 21, 22 that are arranged along multiple rows, transversal to the transport direction 1 of the recording medium 120. Using the nozzles 21, 22 of a print head 103 of the print group 140, dots of a line of a print image may be printed onto the recording medium 120 transversal to the transport direction 1, meaning along the width of the recording medium 120.

The printer 100 also includes a controller 101, for example an activation hardware and/or a processor, that is configured to activate the actuators of the individual nozzles 21, 22 of the individual print heads 103 of the print group 140 in order to apply the print image onto the recording medium 120 depending on print data. In an exemplary embodiment, the controller 101 includes processor circuitry that is configured to perform one or more operations and/or functions of the controller 101, including activating the actuators based on print data, and/or controlling to operation of the printer 100 (including controlling one or more components of the printer 100).

The print group 140 of the printer 100 thus includes at least one print bar 102 with K nozzles 21, 22 that may be activated with a defined line clock cycle or with a defined activation frequency in order to print a line, which line travels transversal to the transport direction 1 of the recording medium 120, with K pixels or K columns 31, 32 of a print image onto the recording medium 120, for example with K>1000. The line clock cycle thus indicates with which timing lines of a print image are printed onto a recording medium 120. The activation frequency thereby typically corresponds to the line clock cycle, so that the nozzles 21, 22 of a print head 103 or print bar 102 may be activated precisely once per line of a print image that is to be printed. In particular, the actuator of a nozzle 21, 22 may be activated (with an ejection pulse) for a line in order to produce an ink ejection for a (non-white) dot in the line, or may be activated in order to produce no ink ejection (for a white dot in the line). In the depicted example, the nozzles 21, 22 are immobile or permanently installed in the printer 100, and the recording medium 120 is directed past the stationary nozzles 21, 22 with a defined transport velocity. The line clock cycle or the activation frequency may be modified accordingly by changing the transport velocity (given a constant dot resolution along the transport direction 1).

The print quality of a print image depends on, among other things, the precision of the positioning of the individual ink droplets of the different nozzles 21, 22 of the inkjet printer 100. The precision of the positioning of an ink droplet thereby depends in particular on the droplet velocity with which an ink droplet is fired by a nozzle 21, 22 onto a recording medium 120. This is presented by way of example in FIG. 1b. In particular, FIG. 1b shows a nozzle 21, 22 via which an ink droplet 131 is ejected outward with a defined droplet velocity 134. The droplet velocity 134 thereby depends on, for example, the deflection of an actuator of the nozzle 21, 22. In particular, the droplet velocity 134 of an ink droplet 131 depends on the pulse, in particular on the waveform of the pulse, with which the actuator of a nozzle 21, 22 is activated. The actuator of a nozzle 21, 22 is thereby typically activated with a defined activation frequency (i.e. according to the line clock cycle) in order to eject ink droplets 131.

On its way to the recording medium 120, the ink droplet 131 flies the route 132, which is typically referred to as a nip. At the same time, the recording medium 120 moves past the nozzle 21, 22 with a defined transport velocity along the transport direction 1. As a result of this, the position 133 (along the transport direction 1) at which the ink droplet 131 strikes the recording medium 120 depends on the transport velocity of the recording medium 120 and on the droplet velocity 134 of the ink droplet 131.

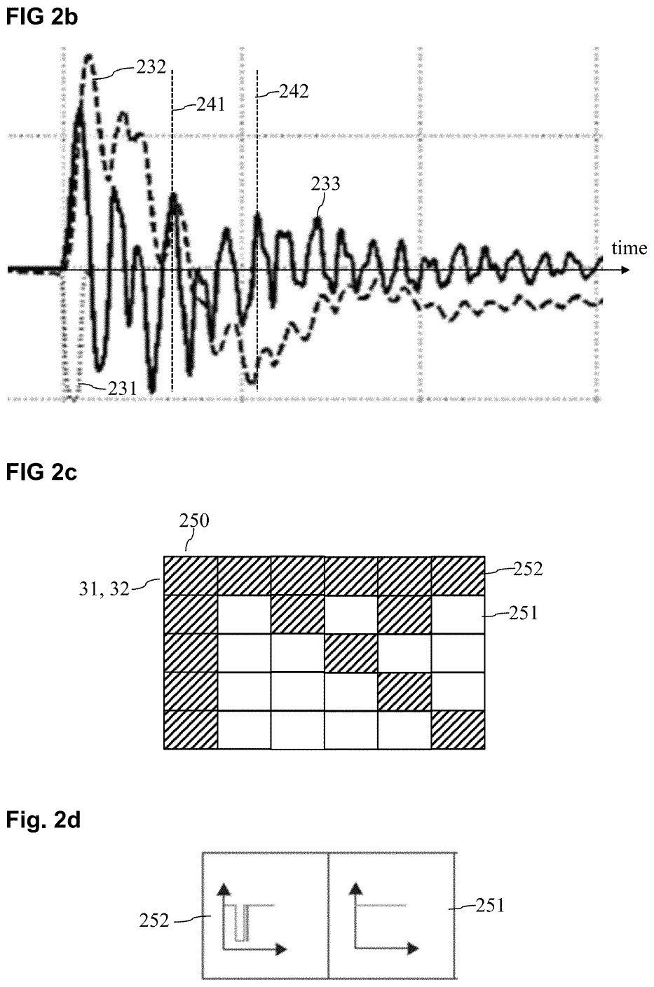

FIG. 2a shows a nozzle arrangement or nozzle 21, 22 of a print head 103 according to an exemplary embodiment. In an exemplary embodiment, the nozzle 21, 22 includes walls 202 which, together with an actuator 220 and a nozzle opening 201, form a container or a chamber 212 to accommodate ink. An ink droplet 131 may be fired or ejected onto the recording medium 120 via the nozzle opening 201 of the nozzle 21, 22. The ink at the nozzle opening 201 forms what is known as a meniscus 210. Furthermore, the nozzle 21, 22 includes an actuator 220 (for example, a piezoelectric element) that is configured to modify the volume of the chamber 212 for accommodating the ink, or to modify the pressure in the chamber 212 of the nozzle 21, 22. In particular, the volume of the chamber 212 may be reduced by the actuator 220 as a result of a deflection 222, and thus the pressure in the chamber 212 may be increased. An ink droplet 131 may thus be ejected from the nozzle 21, 22 via the nozzle opening 201. FIG. 2a shows a corresponding deflection 222 of the actuator 220 (dotted lines). Moreover, the volume of the chamber 212 may be increased by the actuator 220 (see deflection 221) in order to draw new ink into the container or into the chamber 212 via an inlet (not shown in FIG. 2a).

Via a deflection 221, 222 of the actuator 220, the ink within the nozzle arrangement 200 may thus be moved and the chamber 212 may be placed under pressure. A defined movement of the actuator 220 thereby produces a corresponding defined movement of the ink, or of the meniscus 210. The defined movement of the actuator 220 is typically produced by a corresponding defined waveform or a corresponding defined pulse of activation signal of the actuator 220. In particular, via a fire pulse (also referred to as an ejection pulse) for activation of the actuator 220, it may be produced that the nozzle 21, 22 ejects an ink droplet 131 via the nozzle opening 201. Different ink droplets 131 may be ejected via different activation signals or ejection pulses to the actuator 220. In particular, ink droplets 131 with different droplet sizes (for example 5 pl, 7 pl, or 12 pl) may thus be ejected. Furthermore, via a pre-fire pulse (also referred to as a pre-ejection pulse) for activation of the actuator 220 it may be produced that, although the nozzle 21, 22 produces a movement of the ink and an oscillation of the meniscus 210, no ink droplet 131 is thereby ejected via the nozzle opening 201.

FIG. 2b illustrates different measurands of a nozzle 21, 22 according to an exemplary embodiment. In particular, FIG. 2b illustrates an example of a pulse 231 via which the meniscus 210 of the nozzle 21, 22 can be set into oscillation. For example, the pulse 231 may be an ejection pulse. Furthermore, FIG. 2b shows the deflection 232 of the meniscus 210 that is produced by the pulse 231 as a function of time. FIG. 2b also shows the movement or oscillation speed 233 of the meniscus 210 as a function of time.

The oscillation of the meniscus 210 of a nozzle 21, 22 that is produced by a pulse 231 typically has a longer chronological duration than the period duration of one period of the line clock cycle. As a result of this, the meniscus 210 of a nozzle 21, 22 oscillates as a result of an ejection pulse for a dot in a specific line of a print image, even if the actuator 220 of the nozzle 21, 22 is activated with an ejection pulse for a dot of a directly subsequent line of the print image. The ejection pulse for the subsequent line thus produces an oscillation of the meniscus 210 of the nozzle 21, 22 starting from an already present oscillation state of the meniscus 210.

On the other hand, the oscillation of the meniscus 210 of a nozzle 21, 22 decays bit by bit with an increasing number of periods of the line clock cycle if no new pulse 231 for excitation of the meniscus 210 takes place, for example because no non-white dots should be printed. If, after two or more periods of the line clock cycle, an excitation of the meniscus 210 of the nozzle 21, 22 takes place again via an ejection pulse, if applicable an oscillation of the meniscus 210 of the nozzle 21, 22 starting from a rest state of the meniscus 210 is thus produced by the ejection pulse.

An oscillation of the meniscus 210 that is produced starting from an already present oscillation state of the meniscus 210 is typically different than an oscillation of the meniscus 210 that is produced starting from a rest state of the meniscus 210. In particular, the oscillation in the first instance may have a greater or lesser oscillation energy, depending on the phase of the already present oscillation state, than the oscillation in the second instance. As a result of this, the droplet velocity 134 of an ejected ink droplet 131 may also be different for these two instances.

In general, it may thus be maintained that the droplet velocity 134 of an ejected ink droplet 131, and therefore the position 133 of an ink droplet 131 on a recording medium 120, may depend on the oscillation state of the meniscus 210 of a nozzle 21, 22 that the meniscus 210 has when an ejection pulse is produced.

FIG. 2c shows print data, according to an exemplary embodiment, for multiple different lines 250 and multiple different columns 31, 32 of a print image. The print data for a dot in a specific line 250 and in a specific column 31, 32 may thereby indicate that an ejection pulse 252 should take place, or that a pause 251 should take place in which no excitation of the meniscus 210 takes place. The time curves of the corresponding activation signals for the ejection pulse 252 and for the pause 251 are shown by way of example in FIG. 2d.

In the uppermost column 31, 32 in FIG. 2c, the actuator 220 of the corresponding nozzle 21, 22 is activated with an ejection pulse 252 in each period of the line clock cycle. In the second column 31, 32, an activation with an ejection pulse 252 only takes place in every second period etc. As a result of the different periodicity of the ejection pulses 252, the oscillation state of the meniscus 210 of the different nozzles 21, 22 given an ejection pulse 252 is different. The different oscillation states in turn have different droplet velocities 134 and different droplet positionings as a result. The print quality may consequently be negatively affected by the different periodicity of the ejection pulses 252.

FIG. 2e illustrates correlations 261, 262 between the droplet velocity 134 and the activation frequency or the line clock cycle according to an exemplary embodiment. For example, as is clear from the points 262, 263, the droplet velocities 134 for different activation frequencies or line clock cycles may differ significantly from one another. These deviations of the droplet velocities 134 may be explained in that different oscillation states of the meniscus 210 of a nozzle 21, 22 result upon activation with an ejection pulse 252, due to a change of the activation frequency or of the line clock cycle. The different oscillation states of the meniscus 210 may lead to different droplet velocities 134, as presented above.

Furthermore, from FIG. 2e, it is illustrated that the droplet velocity 134 decreases with decreasing activation frequency or with decreasing line clock cycle. This is due to the fact that, at relatively high activation frequencies or relatively quick line clock cycles, the energy that is still present in a nozzle 21, 22 is used in order to eject the ink droplet in a subsequent period of the line clock cycle. As a result of this, relatively little energy is lost given acceleration of the oscillation-capable mass within the nozzle 21, 22. At relatively low activation frequencies or relatively slow line clock cycles, the energy present in a nozzle 21, 22 is relatively low, so that first the entire mass in the nozzle chamber 212 of the nozzle 21, 22 must be accelerated, such that this energy is no longer available for the acceleration of an ink droplet 131.

The insertion of one or more pauses 251 between two ejection pulses 252 may be considered as a whole-number reduction of the activation frequency or, respectively, slowing of the line clock cycle. The printing of a varying number of “white” dots on a column 31, 32 of a print image may consequently lead to varying droplet velocities 134, and thus to varying droplet positionings. The varying droplet positionings may then lead to visible printing artifacts, in particular given homogeneous grid surfaces over a relatively large area.

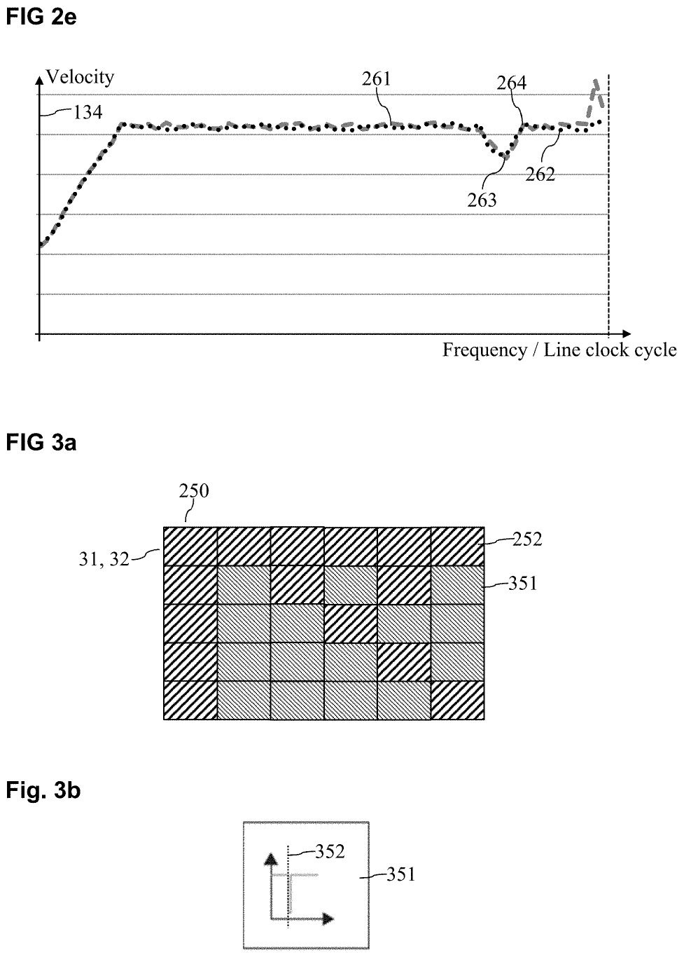

FIG. 3a shows the print data from FIG. 2c, in which the pauses 251 have been replaced by a respective excitation pulse 351 according to an exemplary embodiment. An excitation pulse 351 is thereby designed in order to produce or maintain an oscillation of the meniscus 210 of a nozzle 21, 22 without an ink ejection thereby taking place. The insertion of one or more excitation pulses 351 may have the effect that the oscillation state of the meniscus 210 of a nozzle 21, 22 remains nearly unchanged at each line clock pulse, independently of whether an ejection pulse 252 has been produced or not at a preceding line clock pulse. As a result of this, the droplet velocity 134 of the ink droplets 131 ejected by a nozzle 21, 22 may be adapted.

FIG. 3c shows a time curve of the deflection 232 of a meniscus 210 in reaction to an ejection pulse 252 according to an exemplary embodiment. From FIG. 3c, it is clear that the meniscus 210 exhibits different deflections 232 at different points in time 241, 242. The excitation pulse 351 may exhibit a defined phase 352 that is matched to the oscillation or the deflection 232 of the meniscus 210 that is to be newly excited. For example, the excitation pulse 351 may be matched to the deflection 232 of the meniscus 210 such that the oscillation of the meniscus 210 may be maintained with as little energy as possible. For this purpose, the excitation pulse 251 may be designed in order to be in phase with the oscillation of the meniscus 210.

Between two ejection pulses 252, a bridging pulse and/or excitation pulse 351 may thus be inserted that keeps the meniscus 210 of a nozzle 21, 22 in oscillation such that the ink droplet 131 that is produced by the following ejection pulse 252 is ejected with a defined target droplet velocity 134. For this purpose, the point in time or the phase 352 of the excitation is preferably adapted to the oscillation of the meniscus 210 in order to maintain the oscillation, in particular with as little energy as possible. For example, the excitation in the example depicted in FIG. 3c may preferably take place at the point in time 242. The phase 352 of the excitation pulse 351 may be set accordingly. The phase 352 of an excitation pulse 351 may be determined experimentally, for example.

For example, the phase 352 of the bridging and/or excitation pulse 351 may be adapted to the oscillation of the meniscus 210 such that the bridging and/or excitation pulse 351 is (at least partially) in phase with the oscillation of the meniscus 210 (and thus supports the oscillation of the meniscus 210). In particular, the bridging and/or excitation pulse 351 may be designed and/or chronologically positioned such that the oscillation of the meniscus 210 is supplied with energy in order to maintain said oscillation of the meniscus 210.

In an exemplary embodiment, the excitation pulse 351 is configured to inject precisely so much energy into a nozzle 21, 22 that the meniscus 210 oscillates and no ink ejection thereby takes place. For example, the excitation pulse 351 may be inserted into pause time periods between dots in order to maintain the oscillation of the meniscus 210 of a nozzle 21, 22. The excitation pulse 351 is thereby not directed toward avoiding the drying of ink in a nozzle 21, 22 given relatively long pause time periods, but rather toward maintaining the oscillations in a nozzle 21, 22. The excitation pulse 351 may be used primarily in the printing or raster areas in order to operate the nozzles 21, 22 of a print head 103 optimally close to an optimal working point in such an instance (i.e. as close as possible to a defined target oscillation energy).

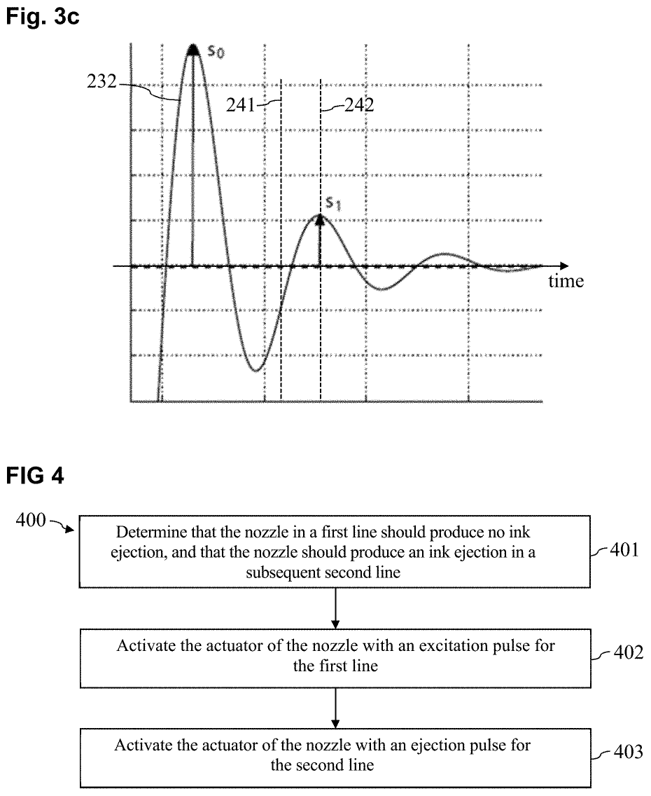

FIG. 4 shows a workflow of a method 400, according to an exemplary embodiment, for improving the positioning of ink droplets 131 of an inkjet printer 100 that includes at least one nozzle 21, 22. The nozzle 21, 22 may include an actuator 220 that may be activated according to a line clock cycle in order to print dots in different lines onto a recording medium 120. Different periods of the line clock cycle may follow one another with a defined period duration, wherein typically precisely one line 250 may be printed by the nozzle 21, 22 in each period.

In an exemplary embodiment, the method 400 includes the determination 401 that no ink ejection should be produced by the nozzle 21, 22 in a first line 250, and that an ink ejection should be produced in a subsequent second line 250. In an exemplary embodiment, this is determined based on the print data with regard to a print image to be printed. It may thus be determined that the nozzle 21, 22 should be prepared for an ink ejection to be produced in the subsequent second line 250.

In an exemplary embodiment, the method 400 includes the activation 402 of the actuator 220 of the nozzle 21, 22 for the first line 250 with an excitation pulse 351. The excitation pulse 351 is configured to produce and/or maintain an oscillation of ink in the ink chamber 220 of the nozzle 21, 22 without an ink droplet 131 being ejected by the nozzle 21, 22. In particular, the excitation pulse 351 may be used to introduce oscillation energy into the nozzle 21, 22 in order to prepare the nozzle 21, 22 for the subsequent ink ejection.

In an exemplary embodiment, the method 400 also includes the activation 403 of the actuator 220 of the nozzle 21, 22 for the second line 250 with an ejection pulse 252 in order to eject an ink droplet 131 from the nozzle 21, 22.

In an exemplary embodiment, the ejection pulse 252 is configured such that an ink droplet 131 with a target droplet velocity 134 is produced, at least statistically on average, by said ejection pulse 252 if the actuator 220 of the nozzle 21, 22 has been activated with an ejection pulse 252 in a directly preceding period of the line clock cycle. In other words, given use of the ejection pulse 252, the ink droplet 131 may—at least statistically on average—have the target droplet velocity 134 if ink ejections take place in lines 250 that directly follow one after another.

On the other hand, in an exemplary embodiment, the ejection pulse 252 is configured such that an ink droplet 131 with a deviating (from the target droplet velocity 134) droplet velocity 134 is produced, for example statistically on average, by said ejection pulse 252 if no excitation—meaning in particular a pause 251—of the actuator 220 of the nozzle 21, 22 has taken place in the directly preceding period of the line clock cycle. The deviating droplet velocity 134 is thereby typically lower than the target droplet velocity 134.

The excitation pulse 351 may be matched to the ejection pulse 252 or be dependent on the ejection pulse 251 such that an ink droplet 131 with a compensated droplet velocity 134 is produced, at least statistically on average, by said ejection pulse 252 if an excitation of the actuator 220 of the nozzle 21, 22 with an excitation pulse 351 has taken place in the directly preceding period of the line clock cycle.

In an exemplary embodiment, the excitation pulse 351 is thereby configured such that the compensated droplet velocity 134 is closer to the target droplet velocity 134 than the deviating droplet velocity 134. In particular, the excitation pulse 351 may be matched to the ejection pulse 252, or may be dependent on the ejection pulse 252, such that the compensated droplet velocity 134 deviates by only 20%, 10%, or less from the target droplet velocity 134.

The actuator 220 of a nozzle 21, 22 of an inkjet printer 100 may thus be activated with an excitation pulse 351 in a current line 250 in preparation for an ejection pulse 252 for printing a dot in a subsequent line 250, wherein an oscillation of ink in the nozzle 21, 22 but no ink ejection is produced by the excitation pulse 351. The oscillation that is produced by the excitation pulse 351 is thereby matched to the ejection pulse 252 such that the ink droplet 131 that is ejected by the ejection pulse 252 in the subsequent line 250 has at least approximately a defined target droplet velocity 134. Via the use of excitation pulses 351, the droplet velocity 134 of the ejected ink droplets 131, and thus the droplet positioning, may thus be homogenized.

Via an excitation pulse 351, the oscillating mass of a nozzle 21, 22 may be set into a defined oscillation state at the beginning of a defined period of the line clock cycle in which an ink ejection should be produced, so that an ink droplet 131 with the compensated droplet velocity 134, which corresponds at least approximately to the target droplet velocity 134, is produced by the ejection pulse 252 in the defined period. The defined oscillation state thereby preferably corresponds at least approximately to the target oscillation state that the oscillating mass of the nozzle 21, 22 would exhibit if an ejection pulse 252 were to have been produced instead of the excitation pulse 351. An compensation of the droplet velocity 134 may thus be achieved particularly reliably and precisely via use of an excitation pulse 351.

As presented above, the ink in the ink chamber 212 of a nozzle 21, 22 typically executes a defined oscillation in reaction to an ejection pulse 251. The excitation pulse 351 may be matched to the ejection pulse 252 such that the oscillation of the ink that is produced by an ejection pulse 251 in a period of the line clock cycle is amplified by the excitation pulse 351 in a subsequent period of the line clock cycle, in particular in a directly following line clock cycle. It may this be achieved that, by maintaining an oscillation that was previously produced by an ejection pulse 251, the oscillating mass of the nozzle 21, 22 at least approximately exhibits the target oscillation state at the end of the subsequent period of the line clock cycle, even without an ink ejection being produced (even if it was not an ejection pulse 252 but rather an excitation pulse 351 that was produced in the subsequent period).

The oscillation of the ink that was produced by an ejection pulse 251 may exhibit a defined phase. The excitation pulse 351, in particular a phase 352 of the excitation pulse 351, may then depend on the phase of the oscillation of the ink that has been produced by an ejection pulse 251. In particular, the excitation pulse 351 may be in phase with the oscillation of the ink that has been produced by a preceding ejection pulse 251. The oscillation of the ink that has been produced in a nozzle 21, 22 by an ejection pulse 251 may thus be particularly efficiently maintained in order to achieve the target oscillation state.

The oscillation of the ink that has been produced by an ejection pulse 251 may exhibit a target oscillation energy (as part of the target oscillation state) at the end of a period of the line clock cycle. The excitation pulse 351 may be designed such that the oscillation that is produced or maintained by the excitation pulse 351 in a period of the line clock cycle deviates by 20%, 10%, or less from the target oscillation energy at the end of the period of the line clock cycle.

Via a sequence of one or more excitation pulses 351, it may thus be produced that the oscillation of ink that has been produced by an ejection pulse 252 in a nozzle is maintained until the actuator 220 of the nozzle 21, 22 is activated with a subsequent ejection pulse 252. In particular, a target oscillation state (with a target oscillation energy and/or a target oscillation phase) may thereby be maintained by the sequence of one or more excitation pulses 351. It may thus be efficiently and reliably produced that the ink droplets 131 that are ejected by the subsequent ejection pulse 252 at least approximately exhibit the target droplet velocity 134.

In an exemplary embodiment, the printer 100 includes a plurality of nozzles 21, 22 for a corresponding plurality of columns 31, 32 to be printed to the recording medium 120. The method 400 that is described in this document may be executed for every single nozzle 21, 22 of the plurality of nozzles 21, 22. In particular, the actuators 220 of at least a portion of the nozzles 21, 22 may respectively be activated with an excitation pulse 351 in a period of the line clock cycle in order to prepare the nozzles 21, 22 for an ejection pulse 351 in a subsequent period of the line clock cycle. Alternatively or additionally, the actuators 220 of at least a portion of the nozzles 21, 22 may be activated with an excitation pulse 351 for at least some of the lines 250 of a print image in which the portion of the nozzles 21, 22 is not activated with an ejection pulse 252.

In an exemplary embodiment, the method 400 includes the detection that a homogeneous raster area should be printed by the plurality of nozzles 21, 22, in which the nozzles 21, 22 of the plurality of nozzles 21, 22 should produce an ink ejection for only a fraction of the lines 250 of the raster area. The method 400 that is described in this document may, if applicable, be limited to the use in conjunction with a homogeneous raster area, for example to raster areas that extend over at least 20, 50, 100, 500, or more lines 250 and/or columns 31, 32. The energy efficiency of a printer 100 may thus be increased.

In an exemplary embodiment, a nozzle 21, 22 of the printer 100 is configured to eject ink droplets 131 with a corresponding plurality of different droplet sizes in reaction to a plurality of different ejection pulses 252. Which ejection pulse 252 from the plurality of different ejection pulses 252 should be used for the second line 250 may be determined within the scope of the method 400. For example, which droplet size the ink droplets 131 that are to be ejected for the second line 250 should exhibit may be determined on the basis of the print data. The excitation pulse 351 for activation of the actuator 220 of the nozzle 21, 22 for the first line 250 may then depend on the determined ejection pulse 252. For example, respective different excitation pulses 351 may be used for the different ejection pulses 252. A uniform droplet positioning may thus be produced even given the use of different ejection pulses 252.

Via the measures described in this document, the print quality of a printer 100 may be efficiently and advantageously increased, in particular with regard to streaking and the printing of homogeneous raster areas.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. A circuit includes an analog circuit, a digital circuit, state machine logic, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction
21, 22 nozzle (of print head 103)
31, 32 column (of the print image)
100 printer
101 controller
102 print bar
103 print head
120 recording medium
131 ink droplet
132 route (nip)
133 position (on recording medium)
134 droplet velocity
140 print group
201 nozzle opening
202 wall
210 meniscus
212 nozzle chamber
220 actuator
221, 222 deflection (actuator)
231 pulse
232 deflection (meniscus)
233 movement velocity (meniscus)
241, 242 point in time
250 line
251 pause
252 ejection pulse
261, 262 correlation of droplet velocity/line clock cycle
263, 264 value point
351 excitation pulse
352 phase (excitation pulse)
400 method to increase the positioning accuracy of ink droplets
401-403 method steps

1. A method for improving the positioning of ink droplets of an inkjet printer including at least one nozzle having an actuator activatable based on a line clock cycle to print dots in different lines on a recording medium, the method comprising:
determining that no ink ejection is to be produced by the nozzle in a first line, and determining an ink ejection is to be produced by the nozzle in a subsequent second line;
activating, based on the determination, the actuator of the nozzle for the first line with an excitation pulse configured to produce and/or maintain an oscillation of ink in an ink chamber of the nozzle without an ink droplet being ejected from the nozzle; and
activating, based on the determination, the actuator of the nozzle for the second line with an ejection pulse to eject an ink droplet from the nozzle, wherein:
the ejection pulse is configured such that:
an ink droplet with a target droplet velocity is produced by the ejection pulse if the actuator of the nozzle is also activated with an ejection pulse for the preceding first line;
an ink droplet with a deviating droplet velocity is produced by the ejection pulse if no excitation of the actuator of the nozzle has taken place;
the excitation pulse is matched to the ejection pulse such that an ink droplet with a compensated droplet velocity is produced by the ejection pulse, since an excitation of the actuator of the nozzle with the excitation pulse has taken place in the first line; and
the compensated droplet velocity is closer to the target droplet velocity than the deviating droplet velocity.

2. The method according to claim 1, wherein:
the ink in the ink chamber of the nozzle executes an oscillation in reaction to the ejection pulse; and
the excitation pulse is matched to the ejection pulse such that the oscillation of the ink that is produced by the ejection pulse in a period of the line clock cycle is amplified by the excitation pulse in a subsequent period of the line clock cycle.

3. Method according to claim 2, wherein the subsequent period of the line clock cycle directly follows the period of the line clock cycle.

4. The method according to claim 2, wherein:
the oscillation of the ink produced by the ejection pulse exhibits a defined phase; and
the excitation pulse depends on the phase of the oscillation of the ink produced by the ejection pulse.

5. The method according to claim 4, wherein a phase of the excitation pulse depends on the phase of the oscillation of the ink produced by the ejection pulse.

6. The method according to claim 2, wherein:
the oscillation of the ink produced by the ejection pulse has a target oscillation energy at an end of the period of the line clock cycle; and
the excitation pulse is configured to produce or maintain the oscillation in the period of the line clock cycle such that oscillation deviates by 20% or less from the target oscillation energy at the end of the period of the line clock cycle.

7. The method according to claim 1, wherein:
the ejection pulse is configured such that an ink droplet with a target droplet velocity is produced by the ejection pulse if the actuator of the nozzle has been activated with a preceding ejection pulse in a directly preceding period of the line clock cycle;
the ejection pulse is configured such that an ink droplet with a deviating droplet velocity is produced by the ejection pulse if no excitation of the actuator of the nozzle has taken place in the directly preceding period of the line clock cycle; and
the excitation pulse is matched to the ejection pulse such that an ink droplet with the compensated droplet velocity is produced by the ejection pulse if an excitation of the actuator of the nozzle has taken place with the excitation pulse in the directly preceding period of the line clock cycle.

8. The method according to claim 1, wherein the excitation pulse is matched to the ejection pulse such that the compensated droplet velocity deviates by 20% or less from the target droplet velocity.

9. The method according to claim 1, wherein:
the printer comprises a plurality of nozzles for a corresponding plurality of columns to be printed onto the recording medium; and
corresponding actuators of at least a portion of the plurality of nozzles are respectively activated with an excitation pulse in a period of the line clock cycle to prepare the plurality of the nozzles for an ejection pulse in a subsequent period of the line clock cycle.

10. The method according to claim 9, wherein the method further comprises:
detecting that a homogeneous raster area is to be printed by the plurality of nozzles, wherein in the homogeneous raster area, the plurality of nozzles are configured to produce an ink ejection for only a fraction of the lines of the homogeneous raster area; and
activating the actuators of at least a portion of the plurality of nozzles with the excitation pulse for at least some of the lines in which the portion of the plurality of nozzles are not activated with an ejection pulse.

11. The method according to claim 1, wherein:
the nozzle is configured to eject ink droplets with a corresponding plurality of different droplet sizes in reaction to a plurality of different ejection pulses;
the method further comprises determining which ejection pulse from the plurality of different ejection pulses is to be used for the second line; and
the excitation pulse depends on the determined ejection pulse from the plurality of different ejection pulses.

12. A non-transitory computer-readable storage medium with an executable program stored thereon, that when executed, instructs a processor to perform the method of claim 1.

13. An inkjet printer for printing to a recording medium, comprising:
at least one nozzle with an actuator activatable according to a line clock cycle to print dots in different lines on the recording medium; and
a controller that is configured to:
determine, based on print data with regard to a print image to be printed, that no ink ejection is to be produced by the nozzle in a first line, and determine an ink ejection is to be produced by the at least one nozzle in a subsequent second line;
activate the actuator of the at least one nozzle with an excitation pulse for the first line, the excitation pulse being configured to produce and/or maintain an oscillation of ink in an ink chamber of the at least one nozzle without an ink droplet being ejected from the at least one nozzle; and
activate the actuator of the at least one nozzle for the second line with an ejection pulse to eject an ink droplet from the at least one nozzle, wherein:
the ejection pulse is configured such that an ink droplet with a target droplet velocity is produced by the ejection pulse if the actuator of the at least one nozzle is also activated with the ejection pulse for the preceding first line;
the ejection pulse is configured such that an ink droplet with a deviating droplet velocity is produced by the ejection pulse if no excitation of the actuator of the at least one nozzle has taken place in the first line;
the excitation pulse is matched to the ejection pulse such that an ink droplet with a compensated droplet velocity is produced by the ejection pulse, since an excitation of the actuator of the at least one nozzle with the excitation pulse has taken place in the first line; and
the compensated droplet velocity is closer to the target droplet velocity than the deviating droplet velocity.
